(19) United States
(12) Patent Application Publication
(10) Pub. No.: US 2001/0021249 A1
(43) Pub. Date: Sep. 13, 2001

(54) Network termination device and method of filtering signals

(76) Inventor: Bagher Aschrafi, Wendlingen (DE)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/791,590

(22) Filed: Feb. 26, 2001

(30) Foreign Application Priority Data
Mar. 9, 2000 (DE) 100 11 121.1

(51) Int. Cl. H04M 1/00

(52) U.S. Cl. 379/390.02

(57) ABSTRACT

Particularly for a communications system in which XDSL is combined with ISDN/POTS, a device (3, 6) for filtering ISDN signals from composite signals containing an ISDN signal component and an ISDN DC component is disclosed which is characterized in that it includes a series combination of a separating filter (8), a filter (9), and a processing module (10), and that the separating filter (8) is adapted to transfer the ISDN signal component via the filter (9) to the processing module (10) and to transfer the ISDN DC component via a separate path to a DC/DC converter (13).

This invention relates to a network termination device as set forth in the preamble of claim 1, to a method of filtering signals as set forth in the preamble of claim 7, and to a device as set forth in the preamble of claim 10.

In many of today's communications networks, subscribers are connected using XDSL technologies. DSL means “digital subscriber line”, i.e., a subscriber is given digital access with a data rate in the megabit range. This is particularly advantageous for a connection to the Internet, since the downloading of information, which frequently includes video information, is accelerated. The letter X stands for A (asynchronous), S (synchronous), H (high bit rate), or V (very high bit rate), for example. An ADSL modem, for example, is installed at the subscriber end to provide access to various services. To integrate Internet services and voice and/or video services, ADSL lines are also used to transmit ISDN (integrated service digital network) services or POTS (plain old telephone service).

The ISDN serves to transmit digital telephone signals and/or digital video-telephone signals, for example. The POTS serves to transmit analog telephone signals.

A subscriber who has had only an analog telephone connection can upgrade his connection with ADSL so that he can continue to telephone via analog facilities but can surf in the Internet at the same time.

Thus, to transmit particularly speech over ADSL, ISDN or POTS is used. ISDN or POTS is transmitted in a first frequency range, and ADSL in a second frequency range. The two frequency ranges do not overlap. A facility is needed which separates ISDN and POTS signals both from one another and from the XDSL signals. Generally, a POTS filter and an ISDN filter are used. Both in the case of ISDN and in the case of POTS, DC components are transmitted along with the user information signals for the purpose of remote power feeding. Because of the DC components, coils are required in the series arms of the filters. The coils are expensive, because they must meet exacting requirements.

The invention discloses a network termination device as set forth in claim 1, a method of filtering signals as set forth in claim 7, and a device as set forth in claim 10.

The invention provides a device which comprises a separating filter for separating a received composite signal containing a signal component and a DC component and a processing module for processing the signal component. A filter is connected between the separating filter and the processing module. The device is preferably designed as an ISDN network termination comprising a separating filter for separating a received composite signal containing an ISDN signal component and an ISDN DC component and a processing module for processing the ISDN signal component. An ISDN filter is connected between the separating filter and the processing module. From two components needed in the prior art, namely an external filter and a commercially available network termination device, which both require an external power supply, a novel network termination device is created which incorporates the filtering property. This reduces the manufacturing costs and the installation costs. The manufacturing costs can be reduced by 60%, since the filter can now be integrated on the existing printed-circuit board, so that the package for the novel network termination device does not differ in size from the package for a commercially available network termination device.

The DC component of the remote power supply is separated from the ISDN user information signals, for example by means of a capacitor, and forwarded over a separate path and used to supply power to the internal components of the device. Thus, the signals to be filtered no longer contain a DC component, i.e., a DC offset. This makes it possible to use filters of a simpler design, for example capacitors in place of coils in the series arms of the filters, or filters with a lower dielectric strength, for example in the range of 10 to 15 volts instead of 100 volts. Capacitors have smaller dimensions than coils, are less expensive, and are easier to incorporate into the circuit. Capacitors are also suitable for integration, which reduces the costs of the filters. The filters can be designed as passive components, whereby power can be saved. The filters can also be constructed from active components using thyristors, for example.

Thus, low-cost integration of ADSL (or SDSL or XDSL) and ISDN, in particular, is made possible in a simple manner.

The invention also provides a method of filtering first signals from composite signals containing a first signal component, a first associated DC component, and a second signal component, the method being characterized in that the first signal component and the first DC component of a received composite signal are separated from one another, that the first signal component is supplied to a given filter, and that the filtered signal component is subsequently processed.

The first signal component is, for example, a digital telephone signal component (e.g., ISDN), the first DC component an associated DC component, and the second signal component a digital data signal component (e.g., XDSL).

Accordingly, the invention is not limited to the integration of ADSL and ISDN or POTS but can be applied in particular to all systems in which at least two different information signals, at least one of which is transmitted together with a DC component, must be separated from one another.

The invention will become more apparent from the following description of an embodiment when taken in conjunction with the accompanying drawings, in which:

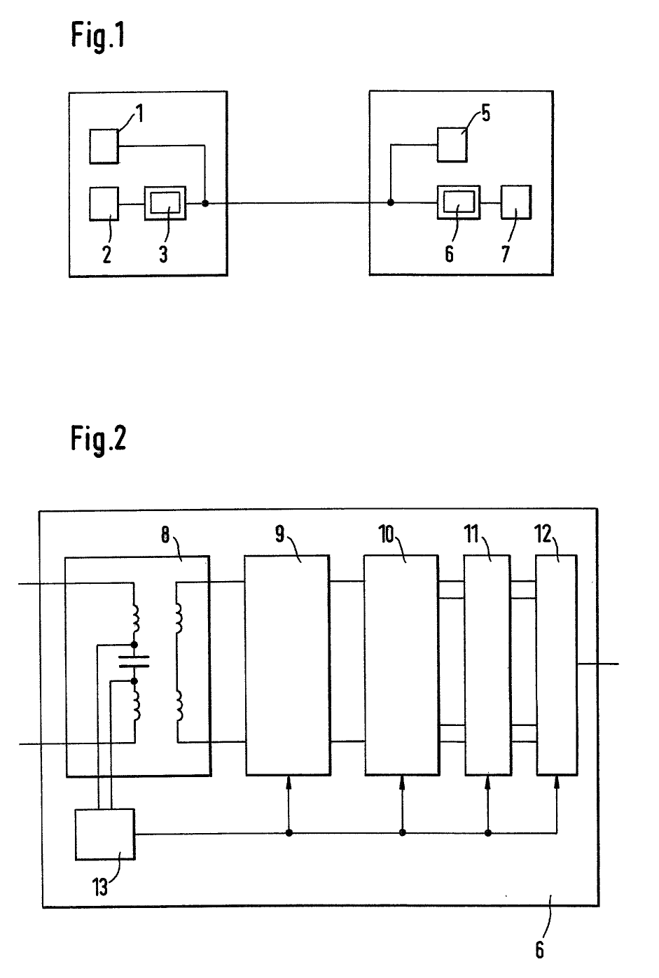

FIG. 1 is a schematic block diagram of a part of a communications network for transmitting ADSL and ISDN/POTS;

FIG. 2 is a schematic block diagram of a device according to the invention; and

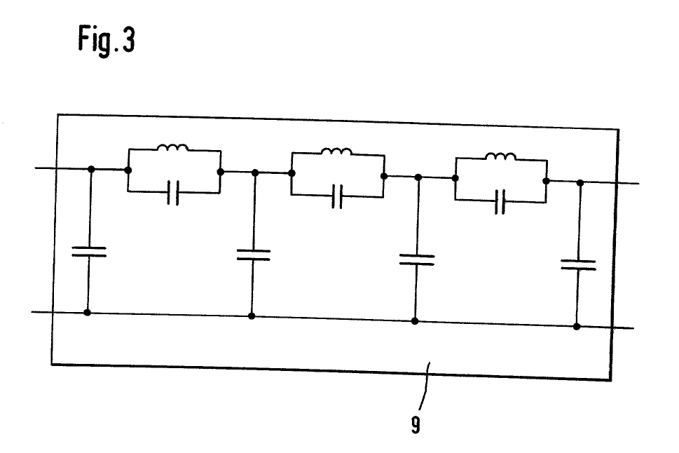

FIG. 3 is a schematic diagram of an embodiment of the filter of the device of FIG. 2.

Referring first to FIG. 1, there is shown a part of a communications network for transmitting ADSL and ISDN/POTS. The communications network is a conventional telephone network, in which there are point-to-point links from an exchange to individual subscribers. The subscribers may be both ISDN and POTS customers. The communications network thus supports both the old, analog lines and digital ISDN lines. In addition, the communications network is ADSL-capable. Each ADSL customer has an ADSL modem 5, via which ADSL traffic, such as Internet access, is handled. Thus, over a line 4 between the exchange and a subscriber, two services are provided simultaneously: ADSL and ISDN or ADSL and POTS. A device 3 at the exchange end and a device 6 at the subscriber end filter the ISDN or POTS signals. In the example shown, the subscriber is an ADSL and ISDN customer. He has an ADSL modem 5 for the ADSL services, and he has a device 6 for filtering the ISDN signals from the composite signal received from the exchange, which contains ADSL signals, ISDN signals, and ISDN DC components. The output signals of the device 6 at the subscriber end contain only ISDN signals (S₀ interface), i.e., the ADSL signals have been removed. Device 6 is additionally designed as an NTBA (Network Termination Basic rate Access) with two bearer channels (two 64-kb/s B channels) and one signaling channel (one 16-kb/s D channel). It thus represents a network termination with integrated filter function which is particularly suitable for use in networks in which aside from ISDN signals, additional services, such as XDSL, are offered which are commonly transmitted in another frequency range, so that the ISDN signals can be separated by means of a filter. Device 6 can also be used in cable television distribution networks that are upgraded with an upstream channel, so that aside from the distribution of television signals, communications services, such as ISDN, can be offered as an overlay. Use of device 6 is also possible in power line networks, in which the ISDN signals must be separated at the subscriber end. Up to eight terminals 7, e.g., an ISDN telephone, a fax machine, a video telephone, etc., can be connected to device 6. The ADSL information transmitted from a subscriber to the exchange, such as request signals, is transferred through an ADSL module 1 into a network independent of the telephone network, e.g., to an Internet service provider. The ISDN information transmitted from a subscriber to the exchange, e.g., telephone signals, is transferred through device 3, which removes all ADSL signals and passes the ISDN signals, to an ISDN module 2 and from there into the ISDN network. Instead of the combination of ADSL and ISDN, a combination of ADSL and POTS can be used. Then, module 2 will be a POTS module and device 6 will be a POTS network termination with integrated filter function. Terminals 7 will be POTS terminals, such as analog telephones.

Referring now to FIG. 2, there is shown a device according to the invention for filtering ISDN signals, which corresponds to device 6 of FIG. 1. Devices 3 and 6 of FIG. 1 are identical in construction except that device 6 additionally includes a module for providing an S₀ interface, and that in device 3, the DC component is fed in, while in device 6, the DC component is received, so that a detailed description of device 3 can be dispensed with. Devices 3 and 6 can be used both for the combination of ADSL and ISDN and for the combination of ADSL and POTS, i.e., they are universally applicable.

Device 6 comprises a series combination of a separating filter 8, a filter 9, a processing module 10, a module 11 for providing a U interface, and a module 12 for providing an S₀ interface. It further includes a DC/DC converter 13.

During the use of an ISDN connection between exchange and subscriber, ISDN signal components (user information) and DC components (for remote power feeding purposes) are transmitted from the exchange to the subscriber. Both the ISDN signal components and the ISDN DC components are received by separating filter 8. Separating filter 8 contains a repeating coil whose primary side is formed by a series combination of a first coil, a capacitor, and a second coil, with the DC component being picked off between the capacitor and the first coil and between the capacitor and the second coil. The secondary side contains a series combination of a third coil and a fourth coil. The repeating coil provides electric isolation, whereby interferences are minimized. The ISDN signal component is transferred from the primary side to the secondary side and fed to filter 9. The ISDN DC component is picked off on the primary side and transferred over separate lines to DC/DC converter 13, i.e., it is not transferred through filter 9 in particular.

Filter 9 is an ISDN filter, which may be a low-pass filter, for example. The low-pass filter has a cutoff frequency of, e.g., 60 MHz. The task of filter 9 is to select and transfer the ISDN signal components in the received composite signal. All signals components below the cutoff frequency are transferred; in the case of an XDSL/ISDN customer, these are the ISDN signals. All signal components above the cutoff frequency are not transferred; in the case of an XDSL/ISDN customer, these are the XDSL signals. The XDSL signals are passed to the XDSL modem, in which they are further processed.

DC/DC converter 13 serves to derive the supply voltage for filter 9 from the remote power supply voltage. Part of the ISDN DC component is converted from, e.g., 100 volts to 5 volts and applied to the ISDN filter. Filter 9 may also be implemented as a passive filter, in which case no power is required. DC/DC conveter 13 also feeds the modules 10, 11, 12.

The ISDN signal components filtered in filter 9 are fed to processing module 10, in which a first evaluation takes place. The processing module contains, for example, a processor, a memory, an equalizer, an encoder, a compressor, a decoder, a decompressor, etc. In module 11, protocol adaptation is performed such that a standardized ISDN U interface is provided. In module 12, protocol adaptation is performed such that a standardized ISDN S₀ interface is provided, which serves as an interface to the ISDN terminals.

DC/DC converter 13 may incorporate a detector that serves to determine which remote power supply voltage is being transmitted. ISDN signals are commonly transmitted together with a supply voltage of about 100 volts. The detector is designed as a threshold detector, for example. The threshold is at 95 volts, for example. Only when a supply voltage is detected will the DC/DC converter, and thus the entire network termination device, be activated. This saves power.

FIG. 3 shows a preferred embodiment of the novel filter 9 of FIG. 2. Filter 9 is an ISDN filter. Its series arm contains three LC sections in series. Each of the LC sections consists of a coil and a capacitor in parallel. Four shunt arms are provided, each of which contains a capacitor. The values of the capacitors and coils are chosen so that these devices can implement the filtering property in the frequency range assigned for the transmission of ISDN signals in an optimized manner. The ISDN filter may also be designed as a dual or equivalent of the above configuration.

In the embodiment, the separating filter contains a repeating coil. Electric isolation can also be provided using a transformer, optocoupler, or gyrator.

1. An ISDN network termination device (3, 6) comprising a separating filter (8) for separating a received composite signal containing an ISDN signal component and an ISDN DC component, and a processing module (10) for processing the ISDN signal component,
characterized in
that an ISDN filter (9) is connected between the separating filter (8) and the processing module (10).

2. An ISDN network termination device (3, 6) as claimed in claim 1, characterized in that the ISDN filter (9) is a low-pass filter.

3. An ISDN network termination device (3, 6) as claimed in claim 1, characterized in that the separating filter (8) comprises a repeating coil having a primary side and a secondary side, that the primary side contains a series combination of a first coil, a capacitor, and a second coil, the DC component being picked off between the capacitor and the first coil and between the capacitor and the second coil, and that the secondary side contains a series combination of a third coil and a fourth coil.

4. An ISDN network termination device (3, 6) as claimed in claim 1, characterized in that a DC/DC converter (13) is provided for deriving the direct current required by the ISDN filter (9) from the detected DC component.

5. An ISDN network termination device (3, 6) as claimed in claim 1, characterized in that the ISDN filter (9) consists of a series arm and at least one shunt arm, with the series arm containing a series combination of at least two LC sections, and each of the shunt arms containing a capacitor.

6. An ISDN network termination device (3, 6) as claimed in claim 1, characterized in that the separating filter (8) contains an optocoupler for providing electric isolation.

7. A method of filtering first signals from composite signals containing a first signal component, a first associated DC component, and a second signal component,
characterized in
that the first signal component and the first DC component of a received composite signal are separated from one another, that the first signal component is supplied to a given filter (9), and that the filtered signal component is subsequently processed.

8. A method as claimed in claim 7, characterized in that the first signal component is an ISDN signal component, the first DC component an ISDN DC component, and the second signal component an XDSL signal component.

9. A method as claimed in claim 7, characterized in that the first signal component is a digital telephone signal component, the first DC component an associated DC component, and the second signal component a digital data signal component.

10. A device (3, 6) comprising a separating filter (8) for separating a received composite signal containing a first signal component and a DC component or for receiving a first signal component, and a processing module (10) for processing the first signal component,
characterized in
that a filter (9) is connected between the separating filter (8) and the processing module (10).

11. A device (3, 6) as claimed in claim 10, characterized in that the received composite signal additionally contains a second signal component or that the separating filter (8) additionally serves to receive a second signal component, and that the filter (9) is adapted to separate the first and second signal components and to transfer only the first signal component.
